(19) United States
(12) Patent Application Publication
(10) Pub. No.: US 2006/0081531 A1
(43) Pub. Date: Apr. 20, 2006

(54) Method for the production of a molecule vector applicable in the field of water treatment and vector thus obtained

(76) Inventors: Phillippe Geffard, Langoiran (FR); Michel Geffard, Talence (FR)

Correspondence Address: YOUNG & THOMPSON, 745 SOUTH 23RD STREET, 2ND FLOOR, ARLINGTON, VA, 22202, US

(21) Appl. No.: 10/540,393

(22) PCT Filed: Dec. 23, 2003
(86) PCT No.: PCT/FR03/50203

§ 371 Date: Jun. 23, 2005

(30) Foreign Application Priority Data
Dec. 24, 2002 (FR) 02 16630

(51) Int. Cl. C02F 1/42

(52) U.S. Cl. 210/502.1; 210/688; 521/30; 521/32

(57) ABSTRACT

The object of the invention is a process for the production of a molecule vector that can be used in water treatment, able to trap heavy ions, characterized in that it comprises the following stages:
Diluting ornithine, NH₂—(CH₂)₃—CH(NH₂)—COOH, in water, Adjusting the pH to a value of between 6.5 and 7.5,
Adding glutaraldehyde, OHC—(CH₂)₃—COH, and Awaiting the polycondensation reaction and the formation of imines, and Recovering the poly(ornithine-G) that is obtained. The invention also covers the vector that is obtained and the use as heavy-ion sensors.

This invention relates to a process for the production of a molecule vector that can be used in water treatment, able to trap heavy ions.

The invention also covers the vector that is obtained from this process.

It is known that water pollution is a significant problem that results from domestic wastes as well as industrial wastes that remain, nevertheless, the most significant source of degradation.

The metallurgic, siderurgical, surface treatment or industrial chemistry industries thus disperse certain pollutants, in particular in this case heavy metals.

It is possible to cite cadmium, which is toxic as of the daily ingestion of more than one milligram of this metal in the form of ions dispersed in water.

Likewise, lead is toxic at a content of 300 mg/l in the blood.

Mercury is also found in crude form or in salt form, and a dose of less than 1 μg/l in drinking water is recommended, which is a difficult threshold to attain.

Chromium derivatives are generated in large quantities by the industry, and accumulation thereof in the lungs in particular leads to serious health problems.

It is also possible to cite tin, aluminum, vanadium, and molybdenum.

Other elements also pollute water with harmful effects, and it is possible to retain the anions such as phosphates, chlorides, sulfates or nitrates. These elements can exhibit carcinogenic effects and primarily disturb the environment by proliferation of certain undesirable plant organisms, corrosion, and taste modification.

There are numerous processes for fighting against these specific pollution incidents. Chemical precipitation incidents, reduction, reverse osmosis or electrolysis are known.

There is also a well-known technique that consists of a passage of fluids to be treated over ion exchange resins.

These resins allow cation or anion exchanges. These resins consist of beads made of an inert material that is used as a substrate such as cross-linked polystyrene, transformed chemically to obtain the desired chemical groups.

One drawback of such resins is the necessity to regenerate them by producing brine that is necessary in turn for treatment by precipitation, for example.

In addition, the greatest drawback is their lack of selectivity that leads them also to remove the potassium, the calcium, the magnesium and the sodium that are essential to drinking water.

The production is also to be carried out in large quantities to reduce the production cost.

There also exist resins that can retain only the above-mentioned heavy metals without retaining potassium, calcium, magnesium and/or sodium, but the grafted groups are thioalcohols that are toxic and therefore banned from human consumption.

In addition, the thus recovered ions are very stable, and the regeneration of resins is difficult.

This invention proposes a process that makes it possible to produce a molecule vector in the form of a polymer that does not require an inert substrate and that traps heavy metals without retaining potassium, calcium, magnesium and/or sodium.

The invention also covers the thus produced vector.

Techniques that are described in particular in Patent Application PCT/FR99/00103 that make it possible to obtain compounds that have a high retention capacity of metallic ions and their anions that are present in the aqueous media are known.

Diamines that are polymerized in the presence of a cross-linking agent are used for this purpose.

The polyamines are poly(L-ornithine-R), poly(putrescine-R), poly(cadaverine-R), poly(L-carnosine-R), poly(spermidine-R) or poly(spermine-R) or else a mixture of the latter. —R represents the polymerizing agent that is reduced with sodium borohydride.

The cross-linking agents that are used are selected from among formaldehyde, glyoxal, malonodialdehyde, although of very high cost, or glutaraldehyde. Another agent is 1,1,3,3-tetramethoxypropane.

Poor polymerization yields are obtained.

The polymerization process that is used consists of a dissolution of the diamine in a basic solution, beyond pH 8.0.

The reduction of the double bonds is also obtained by a sodium borohydride solution, followed by a series of dialyses.

The following polymerization yield is thus obtained: poly(putrescine-G)>poly(cadaverine-G)>poly(L-ornithine-G)>poly(spermidine-G)>poly(L-carnosine-G). -G represents the glutaraldehyde that is reduced with sodium borohydride.

The problem raised by these polymers when they are used for the fluid treatment is the necessity of working in a strongly alkaline medium beyond pH 8.0. The poly(putrescine-G) and the poly(L-carnosine-G) cannot be polymerized at a pH of less than 8.0.

If water is to be treated in very large quantities, it is not conceivable to bring this water to such pH levels to remove the heavy metal ions and then to neutralize it to make it drinkable.

In certain other fields, in particular that of food, the fact of bringing food products to such pH levels is impossible because degradation and irreversible denaturation of these food products take place even if neutralization is then initiated.

Such polymers are also very advantageous because it is possible to generate three-dimensional polymers. Thus, it is possible to get by without substrates by having a maximum exchange surface and a large increase in the final retention capacity.

The L-lysine that was used and polymerized in all its forms is also known, but it remains a molecule whose polymer is of very high cost, incompatible with industrial constraints. This diamine remains a laboratory product or a work product in a very small quantity.

The purpose of this invention therefore is to determine a process that makes it possible to generate polymers that are two-dimensional, or, even better, three-dimensional, starting from a diamine but that work at a neutral pH or a pH that is close to this value of 7.0 and that have a cost compatible with industrial requirements.

The numerous advantages of the product according to this invention will be revealed upon reading the following description.

This process is now described in detail according to a particular, non-limiting embodiment.

The process consists in using a diamine, the L-ornithine, and in polymerizing it in the presence of a compound of the family of dialdehydes, more particularly the glutaraldehyde, to obtain a homopolyamine, the poly(L-ornithine-G).

It is noted, surprisingly enough, that the polymer that is produced under these conditions provides results that are even better than with other diamines, whereby some of them do not polymerize even when they are used alone.

In addition, it is possible to produce a linear homopolymer, but also in 3D, by means of a cross-linking agent thus to form a network.

Comparison tests are carried out by selecting the D or L-citrulline as the diamine that is better able to compete.

This thus makes it possible to show the very superior activities of the thus produced homopolyamine, whereby this selection is novel and particularly inventive, more particularly in its three-dimensional form in its ion-capture role.

This D or L-citrulline diamine is a priori less effective because it uses a CONH₂ group that reduces the availability for the polymerization of the NH₂ group, which is verified by the results that will be mentioned.

The process for the production of the L-ornithine-G homopolyamine according to this invention consists in mixing:

the L-ornithine, for example 10 g in 25 ml of water with adjustment to a pH of between 6.5 and 7.5, more particularly 7.0.
NH₂—(CH₂)₃—CH(NH₂)—COOH,

glutaraldehyde, 20 ml at 50%.
OHC—(CH₂)₃—COH.

The reaction that takes place is a polycondensation reaction with imine formation.

A linear polymer is obtained that can be used by passing through a dialysis system, which leaves such an application in the laboratory stage. Actually, in an industrial setting, the use of dialysis devices would lead to very high costs.

It is necessary to graft the linear polymer to a substrate to allow a suitable manipulation. Such a substrate can be made of activated polystyrene or chlorosulfonated polystyrene.

To obtain a 3D polymer directly, according to the process of this invention, a cross-linking of this polymer is ensured by adding to the medium a cross-linking agent such as polyethylenimine. The addition is carried out in proportions of . . . % of polymer, in this case, 1 ml per 10 g of ornithine.

The polymer that is obtained comes in the form of a three-dimensional polymer.

To produce beads of the homopolymer that is obtained and to make it even easier to manipulate, it is introduced into a hydrophobic organic medium to obtain a two-phase effect. In addition, this medium is advantageously heated to further reduce the time for polymerization of the homopolymer, which becomes almost instantaneous.

To collect the beads thus formed, they are mechanically held quite simply on a filter, then they are dried under a stream of hot air to eliminate the water, on the one hand, and to finalize the cross-linking, on the other hand.

These balls are next degreased and then treated at least once with soda, for example, in 200 ml of 1 M soda at 80° C. for two hours.

This stage makes it possible to remove the protons, otherwise a formation of hydrogen and a mechanical bursting of beads would take place, making them unsuitable for easy manipulation.

This stage can be repeated at least once.

It thus is possible to avoid unnecessarily consuming sodium borohydride since the beads are then placed in a 1 M soda solution in the presence of 1 g/l of sodium borohydride to reduce the double bonds of the imines that are formed.

The beads that are obtained are rinsed with water and 0.001 M hydrochloric acid to neutralize possible alkaline traces and then rinsed with copious amounts of water.

Then, L-ornithine-G homopolymer beads that can retain heavy ions with high effectiveness are obtained.

The following table shows this high retention of heavy metals without thereby retaining potassium, sodium, magnesium and calcium.

| METAL | % | Before Passage mg/l | After Passage mg/l |
|---|---|---|---|
| Al | 73 | 0.51 | 0.14 |
| Cd | 57 | 3.50 | 1.50 |
| Co | 65 | 1.30 | 0.33 |
| Cr | 91 | 0.30 | 0.03 |
| Cu | 80 | 0.53 | 0.13 |
| Fe | 30 | 0.64 | 0.38 |
| Mn | — | <0.01 | <0.01 |
| Ni | 66 | 1.80 | 0.61 |
| Pb | 51 | 3.90 | 1.90 |
| Zn | 65 | 1.60 | 0.55 |
| Ca | 3 | 29.4 | 29.00 |
| K | 3 | 136.90 | 132.80 |
| Mg | 7 | 13.60 | 12.60 |
| Na | 0 | 188.30 | 197.8 |

These results are obtained from a solution with an ion mixture and with a filtration on beads obtained according to the process of this invention, with the proportions of 20 ml of beads, 5 liters of phosphate buffer at pH=7.30, and at 2 l/h. The results correspond to the minima to be obtained because the beads that are used came from the first production runs. Nevertheless, such a test, applied to a wide spectrum of ions, makes it possible to show the effectiveness of this polymer.

Tests were conducted with beads of high quality on the basis of the following considerations:

A sample of charged industrial water has a pH of 3.0, then is adjusted to pH 7.0 by means of 3.5 ml of 4 M NaOH per 9.5 l of sample. The pH can vary from 6.5 to 7.5.

An arsenic solution is added.

1 liter of the sample is taken so as to determine the initial quantities of heavy metals.

Passing through the beads that are obtained by the process according to this invention makes it possible to obtain the water that is also analyzed.

The filtration system comprises a particle filter with a cutoff threshold of 5 μm and 600 ml of resin. The height of the resin bed is 14.5 cm.

The system is washed with 5 l of HCl at 4% then with 5 l of demineralized water.

The beads are conditioned with 3 liters of 2 M phosphate buffer at pH 7.5.

The buffer is removed by means of 5 l of demineralized water.

The rate of flow of the solutions is 10 l/h, including the water sample that is to be analyzed.

The fact of indicating “<” at a value indicates the impossibility of going beyond the threshold for detecting this metal by the measuring device that is used.

The results are indicated below in the following table.

| | Concentration in ppb | Concentration in ppb |
|---|---|---|
| Metals | Before Passage | After Passage |
| Fe | 766 | <10 |
| Pb | 37 | <2 |
| Cr | 202 | <2 |
| Ni | 77 | <5 |
| Cd | 56 | 2.7 |
| Al | 818 | <10 |
| As | 93.3 | <5 |

Thus, it is noted that the values that are obtained are very inferior to the imposed standards.

The calcium, magnesium, potassium and sodium ions are also kept in the same proportions as above.

The homopolyamine that is obtained by the process according to this invention is also tested from the standpoint of the toxicity, and basic tests showed a non-toxicity.

These tests consist in administering 1 mg/ml of poly(L-ornithine-G) solutions at the lethal dose of 3×2 ml to male rats.

A significant weight reduction is not noted.

Likewise, tolerance tests with chronic toxicity are carried out by subjecting young rats to a daily injection at a dose that is less than the lethal dose.

The variation in the weights of these rats is constant with no significant deviation with a weighted curve of control rats.

If a comparison is made with other single amines, it is noted that the L-arginine, urea, and the creatine do not polymerize in the presence of glutaraldehyde under the same conditions.

There is no imine formation by condensation reaction.

If a comparison is made with D, L-citrulline, it is noted that during the polymerization, the yield is much less high, which makes the D, L-citrulline much less suitable for use in an industrial environment.

In a comparison test, 100 mg of L-ornithine and 100 mg of D, L-citrulline that are placed in the presence of 3 ml of 3 M acetate, 1 ml of water and 3 ml of 5% glutaraldehyde are used.

The values of the weights of polymers, attained after freeze-drying, are respectively 23.2 g of poly(ornithine-G) and 7.2 mg of poly(citrulline-G).

The water treatment by means of these poly(L-ornithine-G) beads makes it possible to obtain high-quality waters. These beads find a special application in trapping heavy metals in fresh drinking water or in aqueous nutrient media (for example by removing iron in fruit juices without denaturation, or else for the water that is part of the production of compounds).

The entire description comprises tests with L-ornithine that provides the poly(L-ornithine-G) after polymerization with glutaraldehyde because the monomer is easily available commercially, but it is entirely possible to carry out the same operations with the D-ornithine to obtain the poly(D-ornithine-G).

1. Process for the production of a molecule vector that can be used in water treatment, able to trap heavy ions, characterized in that it comprises the following stages:
Diluting ornithine, NH₂—(CH₂)₃—CH(NH₂)—COOH, in water,
Adjusting the pH to a value of between 6.5 and 7.5,
Adding glutaraldehyde, OHC—(CH₂)₃—COH, and
Awaiting the polycondensation reaction and the formation of imines, and
Recovering the poly(ornithine-G) that is obtained.

2. Process for the production of a molecule vector that can be used in water treatment according to claim 1, wherein the ornithine that is used is the L-ornithine form that leads to the formation of poly(L-ornithine-G).

3. Process for the production of a molecule vector that can be used in water treatment according to claim 1, wherein the linear polymer that is obtained is grafted on a solid substrate.

4. Process for the production of a molecule vector that can be used in water treatment according to claim 3, wherein the linear polymer that is obtained is grafted on activated polystyrene balls or chlorosulfonated polystyrene balls.

5. Process for the production of a molecule vector that can be used in water treatment according to claim 1, wherein a cross-linking agent is added to obtain a 3D poly(L-ornithine-G) network.

6. Process for the production of a molecule vector that can be used in water treatment according to claim 5, wherein the cross-linking agent is polyethylenimine.

7. Process for the production of a molecule vector that can be used in water treatment according to claim 5, wherein the homopolymer that is obtained is dispersed into a hydrophobic organic medium to obtain a two-phase effect or to produce poly(L-ornithine-G) beads.

8. Process for the production of a molecule vector that can be used in water treatment according to claim 7, wherein to collect the thus formed beads, they are mechanically held on a filter and then dried under a stream of hot air.

9. Process for the production of a molecule vector that can be used in water treatment according to claim 7, wherein heating of the hydrophobic organic medium that is used is initiated.

10. Process for the production of a molecule vector that can be used in water treatment according to claim 1, wherein to reduce the double bonds of the imines and to obtain amines, the following operations are initiated:
Degreasing of the polymer that is obtained resulting from the condensation reaction,
Treatment at least once with soda, and
Bringing this polymer into the presence of sodium borohydride.

11. Molecule vector for water treatment, comprising the poly(ornithine-G) that is obtained by the process according to claim 1, in substrate-grafted linear form or in cross-linked form in a three-dimensional network.

12. Use of the vector of claim 11, obtained according to the process of any of claims 1 to 10, wherein it is used for the recovery of heavy metal ions in liquids that have a pH of between 6.5 and 7.5, more particularly 7.0.
